(19) United States
(12) Patent Application Publication
(10) Pub. No.: US 2007/0255961 A1
(43) Pub. Date: Nov. 1, 2007

(54) Systems and methods for coupling a biometric device to a computer

(76) Inventors: Mark S. Tracy, Houston, TX (US); Paul J. Doczy, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/412,522

(22) Filed: Apr. 27, 2006

(51) Int. Cl. H04K 1/00

(52) U.S. Cl. 713/186

(57) ABSTRACT

A computer comprising a biometric device communicatively coupled to operational electronics of the computer and the biometric device being physically coupled to a housing of the computer in a non-removable fashion, the biometric device having an operative surface for receiving biometric input. The computer further comprising a mechanism associated with the biometric device and configured to control movement of the operative surface between extended and retracted positions, wherein the extended position is characterized such that the operative surface is exposed for use and the retracted position is characterized such that the operative surface is not exposed for use.

### BACKGROUND OF THE INVENTION

Many computer systems provide mechanisms for validating or authorizing users. For example, computers are often provided with a login procedure or mechanism, whereby a user is required to enter a login ID (identification) and/or password in order to access operational components of the computer. Providing an authentication or login sequence in this fashion helps protect operational components and resources of the computer from use or access by unauthorized persons. One problem with this sort of authentication or login sequence, however, is that authorized users sometimes forget the assigned password or user ID for the particular computer. Another problem with authentication or login procedures of this type is that unauthorized users may obtain the login or authorization credentials of otherwise authorized users. When this occurs, unauthorized personnel can access the system and its resources.

Improvements over the above-identified type of systems include systems that provide a mechanism to read user-specific biometric data as the mechanism for authorizing access to the computer and its resources. Such biometric devices may include retinal scanners, fingerprint readers, etc. In this regard, fingerprint readers have been provided in PCMCIA (personal computer memory card international association) cards, which can be inserted in and removed from notebook-type computers. Likewise, fingerprint readers have been incorporated into the housing of notebook-type computers near the keyboard. Such a configuration, however, is problematic if a user desires to use the laptop or notebook computer in a closed or folded configuration (as is often the case when a notebook computer is docked in a docking station located in or under a monitor stand). In such a configuration, the panel of the notebook that carries the display is typically closed against the panel of the computer carrying the keyboard, such that the keyboard and biometric device cannot be readily accessed, and therefore, the user cannot be readily authenticated or authorized for use.

Accordingly, further improvements in accessibility or security are desired.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1A is a diagram of a computer having a biometric device coupled to the computer in accordance with an embodiment of the invention, with the biometric device being positioned in a extended position.

FIG. 1B is a diagram of the computer of FIG. 1A, with the biometric device being disposed in a retracted position.

FIG. 2A is a diagram of a computer having a biometric device configured in accordance with an alternative embodiment, and disposed in an extended position.

FIG. 2B is a diagram of the computer of FIG. 2A illustrating the biometric device disposed in a retracted position.

### DETAILED DESCRIPTION OF THE PREFERRED EMBODIMENT

Having summarized various aspects of inventive embodiments, reference will now be made in detail to the description of embodiments as illustrated in the drawings. While the embodiments will be described in connection with these drawings, there is no intent to limit the invention to the embodiment or embodiments disclosed herein. On the contrary, the intent is to cover all alternatives, modifications and equivalents included within the spirit and scope of the invention as defined by the appended claims.

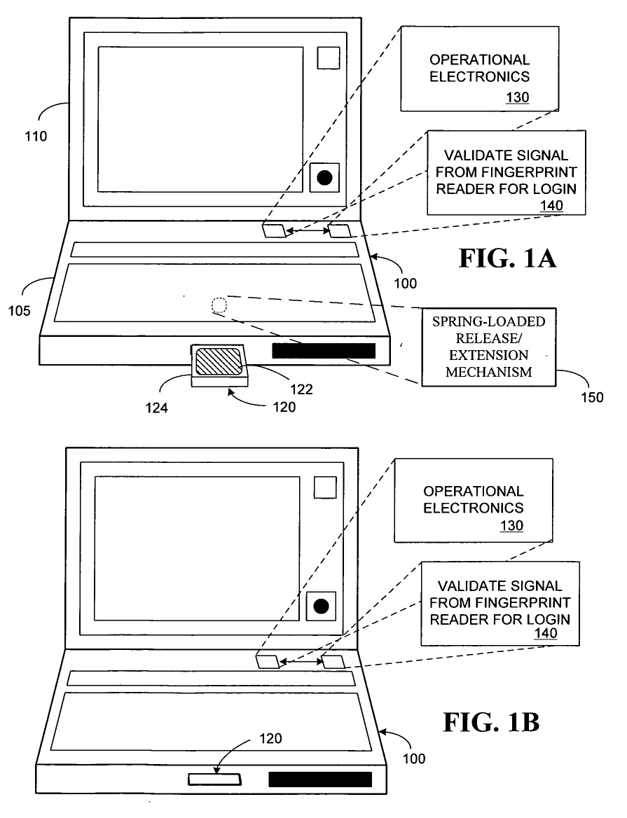

One embodiment of the present invention overcomes the shortcomings of such a configuration, by providing a biometric device that can be accessed for use regardless of whether an associated computer (such as, but not limited to, a notebook computer) is in an open or closed configuration. Reference is made to FIGS. 1A and 1B, which illustrate one embodiment of a notebook computer system having a biometric device. Referring first to FIG. 1A, a notebook computer 100 is defined by a body or housing that comprises both a keyboard portion 105 and a display portion 110. The keyboard portion 105 and the display portion 110 are in rotational relationship (e.g., hinged or otherwise configured for movement between open and closed positions). According to the configuration illustrated in FIG. 1A, a biometric device, such as a fingerprint reader 120, is disposed in a position extended from a front-edge of the notebook computer 100.

The illustrated embodiment of the fingerprint reader 120 includes an operative surface 122 (illustrated by a shaded region in the drawing) for reading relevant data from a fingerprint that is pressed in contact, or placed in proximity, therewith. In this embodiment, the operative surface 122 refers to an active area (such as a sensor membrane or optical scanner) of the biometric device. With such devices, a fingerprint is “read” by extracting data that defines certain characteristics of the fingerprint (e.g., whorl, radial loop, ulnar loop, arch and tented arch).

Consistent with the scope and spirit of the present invention, any suitable fingerprint reader (or other appropriate biometric device) may be implemented in the embodiment of FIG. 1. In this regard, a variety of mechanisms and devices for reading fingerprint data (or obtaining other biometric data) are known. For example, fingerprint readers are known that utilize surface acoustic wave (SAW) membranes for obtaining the relevant fingerprint data and converting that data into electrical form. Fingerprint readers are also known that utilize optics (or optical scanners) to obtain fingerprint data. Still other fingerprint readers utilize capacitance scanners to extract the relevant fingerprint data.

The operative surface 122 is carried on a tray or platform 124, which is configured to position the operative surface 122 between extended and retracted positions. FIG. 1A illustrates the tray 124 in an extended position and FIG. 1B illustrates the tray in a retracted position. As illustrated in FIG. 1B, when the tray is disposed in the retracted position, the operative surface is substantially (or completely) contained within the body of the notebook computer 100 and thus not exposed for use. A mechanism 150 is associated with the fingerprint reader 120 and configured to control movement of the tray 124 between extended and retracted positions.

Consistent with the scope and spirit of the embodiments described herein, any of a variety of suitable mechanisms may be implemented for this purpose. One such mechanism 150 (FIG. 1A) includes a spring-loaded release/extension mechanism. A variety of such mechanisms are well suited for implementing the various embodiments of the invention. An example of one such mechanical mechanism, as used for a different purpose, is disclosed in U.S. Pat. No. 6,665,741. That patent describes the push-push mechanism for removing a PC card or I/O device from a computer. In a similar way, the tray or platform 124 can retract within or extend from the computer housing. The push-push type mechanism utilizes latch/release that operates to release the tray 124 from a retracted and latched position upon a slight depression (e.g., further retraction) of the tray 124, such that the tray is extended with the assist of a spring or other biasing mechanism. Upon being pushed again (from the extended to retracted position), the mechanism latches the tray 124 to remain in the retracted (e.g., latched) position until the tray is again pushed.

Operational electronics 130 or other computer resources are provided within the notebook computer 100. Logic 140 is also provided and configured to validate a signal generated by the fingerprint reader 120 for validating a user in connection with a login or other authorization procedure. In one embodiment, the logic 140 comprises computer code for executing a login or authorization sequence, by comparing data obtained from the fingerprint reader 120 with data previously stored on (or accessible by) the computer. Although the logic 140 is illustrated as being disposed within the computer, in some embodiments it may be fully or partially disposed within the fingerprint reader.

It is contemplated that the fingerprint reader 120 will generally be disposed in the retracted position of FIG. 1B, in order to protect the mechanism from inadvertent harm. When needed, however, for authentication or other reasons, the fingerprint reader 120 may be readily disposed in the extended position of FIG. 1A for convenient access by a user. As can be readily appreciated from the illustrations of FIG. 1A and FIG. 1B, the fingerprint reader 120 is readily accessible regardless of whether the notebook computer 100 is disposed in an open position (as illustrated) or in a closed position (e.g., when placed in a docking station that is located under or in a monitor stand).

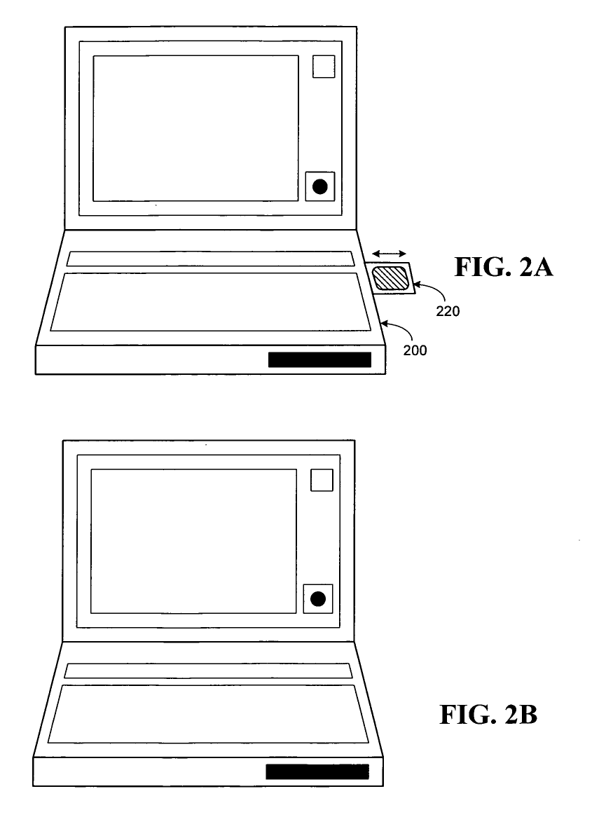

Reference is now made briefly to FIGS. 2A and 2B, which illustrate a notebook computer 200, such as a notebook computer, similar to that of FIGS. 1A and 1B. While the operational electronics and validation logic are not specifically illustrated in FIGS. 2A and 2B, it should be appreciated that these features are provided in the embodiment of FIGS. 2A and 2B. What is relevant for purposes of illustration, however, is the disposition of the fingerprint reader 220 on the side of the notebook computer 200, rather than on the front of the notebook computer 200. In all other respects, the configuration and functional operation of the two embodiments may be the same. It will be appreciated that the fingerprint reader can be disposed in other locations around the computer as well, consistent with the scope and spirit of the invention.

In accordance with certain embodiments of the invention, the fingerprint reader is built into the computer as a permanent fixture thereof. Unlike a PCMCIA or other similar types of circuit cards, the platform 124 is physically coupled to the computer in such a way that it cannot be readily detached from the computer (e.g., non-removably attached). This enhances security by preventing circumvention of the fingerprint reader by simply removing the fingerprint reader from the system (e.g., by ejecting a PCMCIA card). In the illustrated embodiment, the platform 124 is preferably permanently attached to the housing of the computer. Although configured for movement between retracted and extended positions, the platform (and therefore operative components of the fingerprint reader) cannot be removed from the computer, thereby preventing circumvention of the associated security measures associated therewith.

Such security measures may vary from embodiment to embodiment. In one embodiment, the operation of the fingerprint reader may be utilized to verify or complete a login process. In another embodiment, identity verification through the fingerprint reader may be required before the laptop will open to allow user access to the keyboard. Such an embodiment may be implemented by coupling the fingerprint reader to an electronic latch that holds the notebook computer in a latched configuration.

In yet another embodiment, the biometric device may simply be disposed in a stationary configuration at a location on the body of a computer, such that the biometric device is accessible for use at all times. In an embodiment of a notebook computer, the location of the biometric device is selected such that it is accessible regardless of whether the notebook computer is disposed in its open or closed position (e.g., closed for insertion into a docking station underneath a monitor stand). The biometric device is integrated with a body or housing of the computer in a non-removable fashion.

What is claimed is:

1. A portable computer comprising:
a biometric device communicatively coupled to operational electronics of the portable computer, the biometric device being physically coupled to a housing of the portable computer in a non-removable fashion, the biometric device having an operative surface for receiving biometric input; and
a mechanism associated with the biometric device and configured to control movement of the operative surface between extended and retracted positions, wherein the extended position is characterized such that the operative surface is exposed for use and the retracted position is characterized such that the operative surface is substantially contained within the housing and not exposed for use.

2. The portable computer of claim 1, wherein the biometric device is a fingerprint reader.

3. The portable computer of claim 1, wherein the portable computer comprises a body comprising a keyboard portion and a display portion, the keyboard portion in a rotational relationship to the display portion;

4. The portable computer of claim 1, wherein operative surface is disposed on a spring-loaded platform.

5. The portable computer of claim 1, wherein the portable computer is a notebook computer.

6. The portable computer of claim 1, further comprising a software component configured to evaluate data electrically communicated from the biometric device to validate a login procedure.

7. The portable computer of claim 1, wherein biometric device is disposed in an area of the portable computer such that it may be moved between extended and retracted positions irrespective of a rotational position of a keyboard portion with respect to a display portion.

8. A computer comprising:
a biometric device communicatively coupled to operational electronics of the computer and the biometric device being physically coupled to a housing of the computer in a non-removable fashion, the biometric device having an operative surface for receiving biometric input; and
a mechanism associated with the biometric device and configured to control movement of the operative surface between extended and retracted positions, wherein the extended position is characterized such that the operative surface is exposed for use and the retracted position is characterized such that the operative surface is not exposed for use.

9. The computer of claim 8, wherein biometric device comprises a fingerprint reader.

10. The computer of claim 8, wherein the inoperative position is characterized by at least a partial occlusion of the operative surface such that the operative surface is not readily accessible for a reading of a defining biometric.

11. The computer of claim 8, further comprising a platform associated with the biometric device, wherein the operative surface is disposed on the platform.

12. The computer of claim 11, wherein the platform is spring-loaded for movement between the extended position and retracted position.

13. The computer of claim 8, wherein the computer is a notebook computer comprising a body defining a keyboard portion and a display portion, the body being configured to permit movement of the keyboard portion with respect to the display portion between open and closed positions.

14. A portable computer comprising:
a body comprising a keyboard portion and a display portion, the body being configured to permit respective movement of the keyboard portion and the display portion between open and closed positions;
a biometric device coupled to operational electronics of the computer, the biometric device having an operative surface for reading a fingerprint, wherein the operative surface non-removably attached to the body of the portable computer and is disposed in a location of the body that is accessible for use with the body in either the open or closed position.

15. The portable computer of claim 14, wherein the portable computer is a notebook computer.
